(19) United States
(12) Patent Application Publication
(10) Pub. No.: US 2018/0343697 A1
(43) Pub. Date: Nov. 29, 2018

(54) UE Category and Capability Indication for Co-existed LTE and NR Devices

(71) Applicant: MEDIATEK INC., Hsinchu (TW)

(72) Inventors: Chia-Chun Hsu, Hsinchu (TW); I-Kang Fu, Hsinchu (TW); Hsin-Ying Lee, Hsinchu (TW)

(21) Appl. No.: 15/989,661

(22) Filed: May 25, 2018

Related U.S. Application Data
(60) Provisional application No. 62/511,372, filed on May 26, 2017.

(51) Int. Cl. H04W 76/16; H04W 76/27; H04W 88/06

(52) U.S. Cl. CPC H04W 76/16; H04L 5/001; H04W 88/06; H04W 76/27

(57) ABSTRACT

A method of UE category and capability indication for co-existed 4G LTE and 5G New Ratio (NR) devices is proposed. UE indicates UE category and associated capability for standalone NR, which includes band combination for NR and a list of capability combinations of baseband feature sets. UE also indicates separate UE category and associated capability for 5G NR EN-DC (EUTRA-NR Dual Connectivity), which includes band combination for NR+LTE, and a list of capability combinations of baseband feature sets. Based on such indication, the network can enable the UE to operate over multiple connections via multiple radio access technology (RATs) concurrently. In one novel aspect, the baseband feature set combination is band combination agnostic.

### CROSS REFERENCE TO RELATED APPLICATION

This application claims priority under 35 U.S.C. § 119 from U.S. Provisional Application No. 62/511,372, entitled “UE Category of co-existed LTE, NR device,” filed on May 26, 2017, the subject matter of which is incorporated herein by reference.

### TECHNICAL FIELD

The disclosed embodiments relate generally to wireless communication systems, and, more particularly, to user equipment (UE) category and capability indication of co-existed LTE and NR devices.

### BACKGROUND

3GPP Long-Term Evolution (LTE) systems offer high peak data rates, low latency, improved system capacity, and low operating cost resulting from simple network architecture. A 3GPP LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. In LTE/LTE-A systems, an evolved universal terrestrial radio access network (E-UTRAN) includes a plurality of evolved Node-Bs (eNBs) communicating with a plurality of mobile stations, referred as user equipments (UEs).

The signal bandwidth for next generation 5G new radio (NR) system is estimated to increase to up to hundreds of MHz for below 6 GHz bands and even to values of GHz in case of millimeter wave bands. Furthermore, the NR peak rate requirement can be up to 20 Gbps, which is more than ten times of LTE. Three main applications in 5G NR system include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported.

For LTE and NR multi-mode UE, it is possible for UE to share common baseband processing resource to support both LTE and NR. It is thus reasonable to consider the maximum number of transport block (TB) bits received or transmitted within a transmission time interval (TTI) across LTE and NR under the non-standalone (NSA) architecture. For LTE and NR multi-mode UE which supports standalone (SA) architecture, it may also require to support simultaneously connections with LTE and NR (e.g. by dual-registration). Following the same UE architecture to share common baseband processing resource for LTE and NR, it will be reasonable to consider the maximum number of TB bits received or transmitted within a TTI across LTE and NR under the SA architecture as well.

For LTE and NR multi-mode UE, it is possible for UE to share common RF resources to support both LTE and NR for Sub-6 GHz band. It is thus reasonable to ensure that the frequency range used for LTE shall not overlap with the one for NR under the non-standalone (NSA) architecture. For LTE and NR multi-mode UE which supports standalone (SA) architecture, it may also require to support simultaneously connections with LTE and NR (e.g. by dual-registration). Following the same UE architecture to share common RF resources for LTE and NR, it is reasonable to ensure that the frequency range used for LTE shall not overlap with the one for NR under the SA architecture as well.

It is essential for LTE and NR multi-mode UE to indicate separate UE category and associated capability to the network.

### SUMMARY

A method of UE category and capability indication for co-existed 4G LTE and 5G New Ratio (NR) devices is proposed. UE indicates UE category and associated capability for standalone NR, which includes band combination for NR and a list of capability combinations of baseband feature sets. UE also indicates separate UE category and associated capability for 5G NR EN-DC (EUTRA-NR Dual Connectivity), which includes band combination for NR+LTE, and a list of capability combinations of baseband feature sets. Based on such indication, the network can enable the UE to operate over multiple connections via multiple radio access technology (RATs), e.g., NR and LTE, concurrently.

In one novel aspect, the supported baseband feature set combination is band combination agnostic. The UE indicates supported baseband feature set per band using a separate table. For each band combination, the UE includes an index to refer to the corresponding entry in the supported baseband feature set per band table. Similarly, the UE indicates supported baseband feature set per component carrier (CC) using a separate table. For each supported baseband feature set per band, the UE includes an index to refer to the corresponding entry in the supported baseband feature set per CC table.

In one embodiment, a multi-RAT UE receives a capability enquiry from a master node in a wireless communication system. The UE transmits UE capability information to the master node. The UE capability information comprises UE band combination indication and UE supported baseband feature set indication. The band combination indication comprises a first band index with a first maximum bandwidth for a first radio access technology (RAT) and a second band index with a second maximum bandwidth for a second RAT. The UE establishing a first connection with the master node using the first RAT. The UE establishes a second connection with a secondary node using the second RAT. The UE operates on the first connection and the second connection within the indicated UE capability concurrently.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an LTE and NR multi-RAT user equipment (UE) supporting UE category and associated capability indication in a 4G/5G network in accordance with one novel aspect.

FIG. 2 is a simplified block diagram of an LTE and NR multi-RAT UE supporting UE category and capability indication in accordance with one novel aspect.

FIG. 3 illustrates a simple message flow between a UE and an NR master node and an LTE secondary node for indicating UE category and capability and supporting simultaneous connections with NR and LTE.

FIG. 4 illustrates embodiments of UE capability signaling structure comprising band combination for both NR and LTE and corresponding baseband feature sets.

FIG. 5 illustrates examples of band combination indication and baseband feature sets indication for both NR and LTE.

FIG. 6 is a flow chart of a method of UE category and capability indication for LTE and NR multi-RAT UEs in accordance with one novel aspect.

### DETAILED DESCRIPTION

Reference will now be made in detail to some embodiments of the invention, examples of which are illustrated in the accompanying drawings.

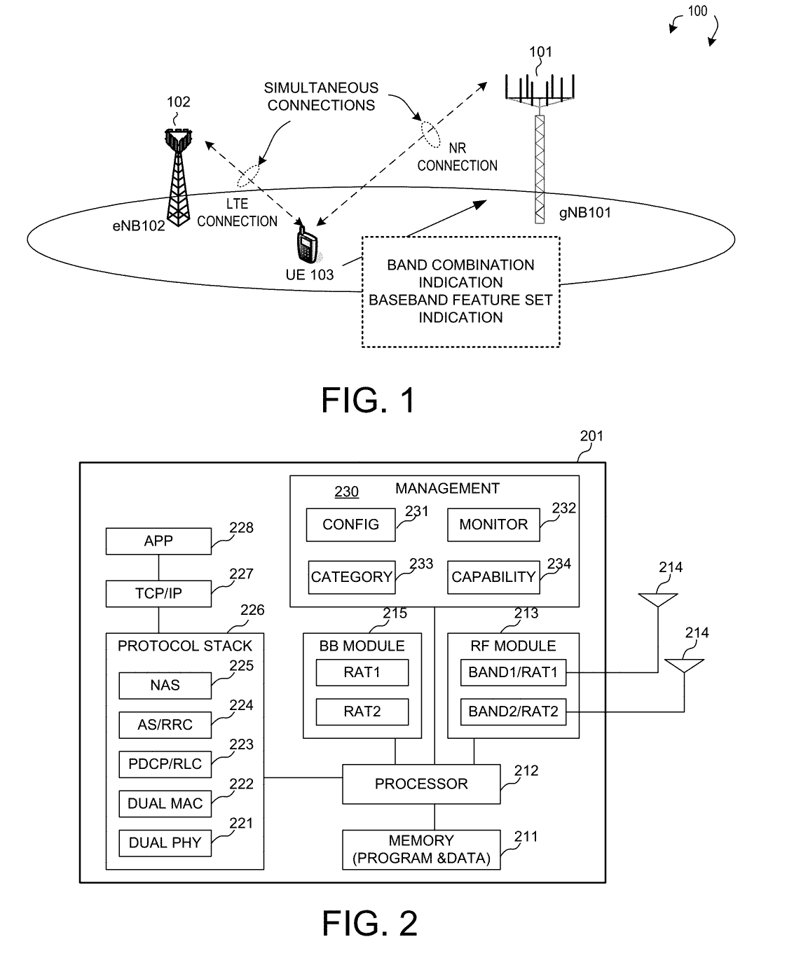

FIG. 1 illustrates an LTE and NR multi-RAT user equipment (UE) supporting UE category and associated capability indication in a 4G/5G network in accordance with one novel aspect. In next generation 5G systems, a base station (BS) is referred to as gNB 101. In 4G LTE/LTE-A systems, an evolved universal terrestrial radio access network (E-UTRAN) includes a plurality of base stations, referred as evolved Node-Bs (eNodeBs or eNBs) (e.g., eNB 102) communicating with a plurality of mobile stations, referred as user equipments (UEs) (e.g., UE 102). The concept of carrier aggregation (CA) has been introduced to enhance the system throughput. With CA, two or more component carriers (CCs) are aggregated to support wider transmission bandwidth up to 100 MHz. The demand for higher bandwidth may require exploiting further on CA operation to aggregate cells from different base stations to serve a single UE, called inter-base station carrier aggregation (inter-eNB CA). In DuCo (dual connectivity), a UE is simultaneously connected to a master BS node and a secondary BS node.

For LTE and NR multi-mode UE, it is possible for UE to share common RF resources and baseband processing resource to support both LTE and NR, e.g., over multiple radio access technology (RAT). It is reasonable to ensure that the frequency range used for LTE shall not overlap with the one for NR under the non-standalone (NSA) architecture. Furthermore, it is reasonable to consider the maximum number of transport block (TB) bits received or transmitted within a transmission time interval (TTI) across LTE and NR under the non-standalone (NSA) architecture. For LTE and NR multi-mode UE which supports standalone (SA) architecture, it may also require to support simultaneously connections with LTE and NR (e.g. by dual-registration). Following the same UE architecture to share common RF resources and baseband processing resource for LTE and NR, it will be reasonable to ensure that the frequency range used for LTE shall not overlap with the one for NR under the SA architecture, it will also be reasonable to consider the maximum number of TB bits received or transmitted within a TTI across LTE and NR under the SA architecture.

In accordance with one novel aspect, a method of UE category and capability indication for co-existed 4G LTE and 5G New Ratio (NR) devices is proposed. The UE indicates UE category and associated capability for standalone NR, which includes band combination for NR and a list of capability combinations of baseband feature sets. UE also indicates separate UE category and associated capability for 5G NR EN-DC (EUTRA-NR Dual Connectivity), which includes band combination for NR+LTE, and a list of capability combinations of baseband feature sets. In the example of FIG. 1, gNB 101 is a master node and eNB 102 is a secondary node. UE 103 sends band combination indication and baseband feature set indication to master node eNB 101. UE 103 is then configured by gNB 101 to operate over LTE connection with eNB 102 and over NR connection with gNB 101 concurrently.

In one advantageous aspect, the supported baseband feature set combination is band combination agnostic. The UE indicates supported baseband feature set per band using a separate table. For each band combination, the UE includes an index to refer to the corresponding entry in the supported baseband feature set per band table. Similarly, the UE indicates supported baseband feature set per CC using a separate table. For each supported baseband feature set per band, the UE includes an index to refer to the corresponding entry in the supported baseband feature set per CC table.

FIG. 2 is a simplified block diagram of a UE for mobility management with power consumption enhancements in accordance with one novel aspect. UE 201 has an antenna (or antenna array) 214, which transmits and receives radio signals. A RF transceiver module (or dual RF modules) 213, coupled with the antenna, receives RF signals from antenna 214, converts them to baseband signals and sends them to processor 212 via baseband module (or dual BB modules) 215. RF transceiver 213 also converts received baseband signals from processor 212 via baseband module 215, converts them to RF signals, and sends out to antenna 214. Processor 212 processes the received baseband signals and invokes different functional modules to perform features in UE 201. Memory 211 stores program instructions and data to control the operations of UE 201.

UE 201 also includes a 3GPP/NR protocol stack module 226 supporting various protocol layers including NAS 225, AS/RRC 224, PDCP/RLC 223, dual MAC 222 and dual PHY 221, a TCP/IP protocol stack module 227, an application module APP 228. UE 201 with dual connectivity has two MAC entities. Two sets of upper layer stacks (RLC/PDCP) are configured for the MAC entities. At the RRC layer, only one RRC 224 is configured. RRC 224 controls the protocol stacks in corresponding to the MAC entities by communicating with the RRC entity of its serving master node.

UE 201 further comprises a management circuit 230 including a configuration circuit 231, a measurement circuit 232, a UE category circuit 233, and a capability reporting circuit 234. The circuits are function modules that can be configured and implemented by hardware, firmware, and software, or any combination thereof. The function modules, when executed by processor 212 (via program instructions and data contained in memory 211), interwork with each other to allow UE 201 to perform certain embodiments of the present invention accordingly. Configuration circuit 231 obtains configuration information from its serving master node and applies corresponding parameters, monitor circuit 232 performs radio link monitoring (RLM) and radio link failure (RLF) procedure, UE category circuit 233 determines UE category being a standalone or non-standalone architecture, and capability reporting circuit 234 reports band combination and a list of capability combinations of baseband feature sets for standalone NR and for EN-DC DuCo. In one example, RF module 213 can be shared to support both band1/RAT1 and band2/RAT2, while BB module 215 can be shared to process both RAT1 and RAT2 simultaneously.

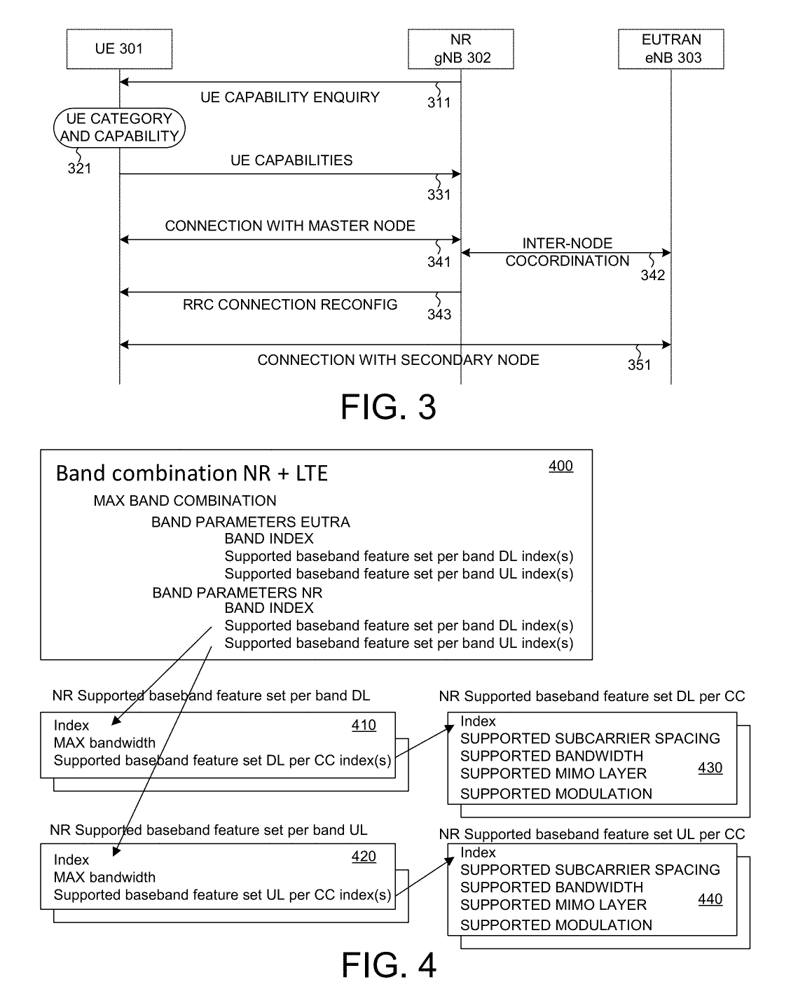

FIG. 3 illustrates a simple message flow between a UE 301 and an NR master node gNB 302 and an LTE secondary node eNB 303 for indicating UE category and capability and supporting simultaneous connections with NR and LTE. UE 301 is a multi-RAT UE supporting EN-DC DuCo. In step 311, UE 301 receives a capability enquiry from its master base station gNB 302. In step 321, UE 301 determines its UE category and associated capability that comprises band combination indication and supported baseband feature set indication. In step 331, UE 301 sends its UE category and associated capability to its master node gNB 302. In step 341, UE 301 establishes a first connection with its master node gNB 302 in NR. In step 342, gNB 302 determines the UE capabilities and performs inter-node coordination with eNB 303. For example, eNB 302 knows that UE 301 supports EN-DC DuCo and can share RF and baseband capabilities between NR and LTE simultaneously. As a result, in step 343, gNB 302 sends an RRC connection reconfiguration to UE 301. In step 351, UE 301 establishes a second connection with its secondary node eNB 303 in E-UTRAN, based on the RRC connection reconfiguration. UE 301 can operation on the first connection and the second connection concurrently under EN-DC DuCo.

FIG. 4 illustrates embodiments of UE capability signaling structure comprising band combination for both NR and LTE and corresponding baseband feature sets. For standalone NR, the band combination list comprises a list of supported band combinations for a maximum number of band combinations. Each band combination comprises a set of band combination parameters including a band index and one or more supported baseband feature set indexes. Similarly, for 5G NR EN-DC, the band combination list comprises a list of band combination for a maximum number of simultaneously supported band combinations as depicted by 400. Each band combination comprises a set of band combination parameters for EUTRA and a set of band combination parameters for NR. The band combination parameters for EUTRA include a band index and one or more supported baseband feature set indexes for LTE, the band combination parameters for NR also include a band index and one or more supported baseband feature set indexes for NR.

The capability combinations of baseband feature sets are indicated through a list of supported baseband feature set per band using a separate table. Each supported baseband feature set per band can be either a supported baseband feature set per band for downlink (e.g., box 410), or a supported baseband feature set per band for uplink (e.g., box 420). The supported baseband feature set per band comprises an index, a maximum bandwidth, and one or more supported baseband feature set per CC indexes. The supported baseband feature set per CC further comprise an index, a supported bandwidth, a supported MIMO layer, a supported modulation, and a supported subcarrier spacing per CC, as depicted by 430 or 440.

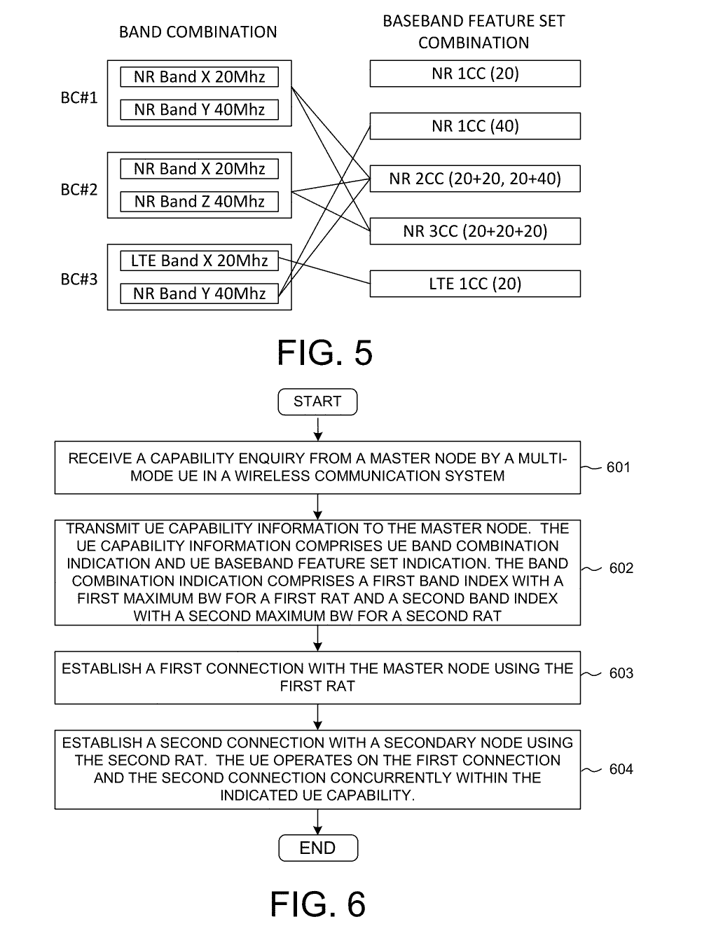

FIG. 5 illustrates examples of band combination indication and baseband feature sets indication for both NR and LTE. In the example of FIG. 5, a UE supports three different band combinations. The UE also supports a list of baseband feature set combinations that are indexed separately. For band combination BC#1, it comprises NR band X with 20 MHz maximum BW, and NR band Y with 40 MHz maximum BW. BC#1 also include indexes that refer to the corresponding baseband feature sets, e.g., a first baseband feature set of NR 2CC supporting two CCs with 20+20 or 20+40 MHz, and a second baseband feature set of NR 3CC supporting three CCs with 20+20+20 MHz. For band combination BC#2, it comprises NR band X with 20 MHz maximum BW, and NR band Z with 40 MHz maximum BW. BC#2 also include indexes that refer to the corresponding baseband feature sets, e.g., a first baseband feature set of NR 2CC supporting two CCs with 20+20 or 20+40 MHz, and a second baseband feature set of NR 3CC supporting three CCs with 20+20+20 MHz. Similarly, for band combination BC#3, it comprises LTE band X with 20 MHz maximum BW, and NR band Y with 40 MHz maximum BW. BC#3 also include indexes that refer to the corresponding supported baseband feature sets, e.g., the LTE band X is associated with a baseband feature set of LTE 1CC supporting 20 MHz, and the NR band Y is associated with a first baseband feature set of NR 1CC supporting 40 MHz, and a second baseband feature set of NR 2CC supporting two CCs with 20+20 or 20+40 MHz.

FIG. 6 is a flow chart of a method of UE category and capability indication for LTE and NR multi-RAT UEs in accordance with one novel aspect. In step 601, a UE receives a capability enquiry from a master node in a wireless communication system. In step 602, the UE transmits UE capability information to the master node. The UE capability information comprises UE band combination indication and UE supported baseband feature set indication. The band combination indication comprises a first band index with a first maximum bandwidth for a first radio access technology (RAT) and a second band index with a second maximum bandwidth for a second RAT. In step 603, the UE establishing a first connection with the master node using the first RAT. In step 604, the UE establishes a second connection with a secondary node using the second RAT. The UE operates on the first connection and the second connection within the indicated UE capability concurrently.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a capability enquiry from a master node by a multi-mode user equipment (UE) in a wireless communication system;
transmitting UE capability information to the master node, wherein the UE capability information comprises UE band combination indication and UE supported baseband feature set indication, wherein the band combination indication comprises a first band index with a first maximum bandwidth for a first radio access technology (RAT) and a second band index with a second maximum bandwidth for a second RAT;
establishing a first connection with the master node using the first RAT; and
establishing a second connection with a secondary node using the second RAT, wherein the UE operates on the first connection and the second connection within the indicated UE capability concurrently.

2. The method of claim 1, wherein the first RAT is over 5G/NR (new radio), and wherein the second RAT is via 4G/LTE EUTRAN (evolved universal terrestrial radio access network).

3. The method of claim 1, wherein the second RAT is over 5G/NR (new radio), and wherein the first RAT is via 4G/LTE EUTRAN (evolved universal terrestrial radio access network).

4. The method of claim 1, wherein the UE shares radio frequency (RF) capability for the concurrent first connection and the second connection.

5. The method of claim 1, wherein the UE shares baseband processing capability for the concurrent first connection and the second connection.

6. The method of claim 1, wherein the band combination indication further comprises one or more UE supported baseband feature set indexes.

7. The method of claim 1, wherein the UE supported baseband feature set indication comprises supported baseband feature set per band, which further comprising one or more supported baseband feature set per component carrier (CC) indexes, and/or a maximum bandwidth.

8. The method of claim 7, wherein each of the supported baseband feature set per CC indexes refers to a bandwidth per CC, a supported multiple-input multiple-output (MIMO) layer, a supported modulation, and a supported subcarrier spacing per CC.

9. The method of claim 7, wherein the UE maintains a supported baseband feature set per band table, wherein for each band combination, the UE includes one or more indexes to refer to corresponding one or more entries in the supported baseband feature set per band table.

10. The method of claim 7, wherein the UE maintains a supported baseband feature set per CC table, wherein for each band combination and each supported baseband feature set per band, the UE includes one or more indexes to refer to corresponding one or more entries in the supported baseband feature set per CC table.

11. A user equipment (UE), comprising:
a radio frequency (RF) receiver that receives a capability enquiry from a master node in a wireless communication system;
an RF transmitter that transmits UE capability information to the master node, wherein the UE capability information comprises UE band combination indication and UE supported baseband feature set indication, wherein the band combination indication comprises a first band index with a first maximum bandwidth for a first radio access technology (RAT) and a second band index with a second maximum bandwidth for a second RAT; and
a configuration circuit that establishes a first connection with the master node using the first RAT, wherein the UE also establishes a second connection with a secondary node using the second RAT, and wherein the UE operates on the first connection and the second connection within the indicated UE capability concurrently.

12. The UE of claim 11, wherein the first RAT is over 5G/NR (new radio), and wherein the second RAT is via 4G/LTE EUTRAN (evolved universal terrestrial radio access network).

13. The UE of claim 11, wherein the second RAT is over 5G/NR (new radio), and wherein the first RAT is via 4G/LTE EUTRAN (evolved universal terrestrial radio access network).

14. The UE of claim 11, wherein the UE shares radio frequency (RF) capability for the concurrent first connection and the second connection.

15. The UE of claim 11, wherein the UE shares baseband processing capability for the concurrent first connection and the second connection.

16. The UE of claim 11, wherein the band combination indication further comprises one or more UE supported baseband feature set indexes.

17. The UE of claim 11, wherein the UE supported baseband feature set indication comprises supported baseband feature set per band, which further comprising one or more supported baseband feature set per component carrier (CC) indexes, and/or a maximum bandwidth.

18. The UE of claim 17, wherein each of the supported baseband feature set per CC indexes refers to a bandwidth per CC, a supported multiple-input multiple-output (MIMO) layer, a supported modulation, and a supported subcarrier spacing per CC.

19. The UE of claim 17, wherein the UE maintains a supported baseband feature set per band table, wherein for each band combination, the UE includes one or more indexes to refer to corresponding one or more entries in the supported baseband feature set per band table.

20. The UE of claim 17, wherein the UE maintains a supported baseband feature set per CC table, wherein for each band combination and each supported baseband feature set per band, the UE includes one or more indexes to refer to corresponding one or more entries in the supported baseband feature set per CC table.
